(19) United States
(12) Patent Application Publication
(10) Pub. No.: US 2026/0180640 A1
(43) Pub. Date: Jun. 25, 2026

(54) WIRELESS COMMUNICATION METHOD, AND COMMUNICATION DEVICE

(71) Applicant: GUANGDONG OPPO MOBILE TELECOMMUNICATIONS CORP., LTD., Dongguan (CN)

(72) Inventors: Yi ZHONG, Dongguan (CN); Ziyi ZUO, Dongguan (CN); Yapu LI, Dongguan (CN); Ning GAO, Dongguan (CN); Chaoming LUO, Dongguan (CN); Liuming LU, Dongguan (CN); Jun ZHANG, Dongguan (CN)

(73) Assignee: GUANGDONG OPPO MOBILE TELECOMMUNICATIONS CORP., LTD., Dongguan (CN)

(21) Appl. No.: 19/541,228

(22) Filed: Feb. 16, 2026

Related U.S. Application Data
(63) Continuation of application No. PCT/CN2023/114540, filed on Aug. 23, 2023.

(51) Int. Cl. H04B 7/06

(52) U.S. Cl. CPC H04B 7/0617

(57) ABSTRACT

Provided are a wireless communication method, and a communication device. The method comprises: a first device sending first indication information to a second device, wherein the first device is a device for determining a beamforming feedback angle, and the first indication information is used for indicating a first quantization bit number of the beamforming feedback angle.

### CROSS-REFERENCE TO RELATED APPLICATIONS

This application is a continuation of International Application No. PCT/CN2023/114540, filed on Aug. 23, 2023, the disclosure of which is hereby incorporated by reference in its entirety.

### TECHNICAL FIELD

This application relates to the field of communications technologies, and more specifically, to a wireless communication method and a communications device.

### BACKGROUND

In a beamforming process, a beamforming feedback angle (referred to as a feedback angle) is required to be quantized. A quantity of quantization bits for the feedback angle affects feedback overheads in the beamforming process. A larger quantity of quantization bits for the feedback angle indicates greater feedback overheads, and a smaller quantity of quantization bits for the feedback angle indicates lower feedback overheads. In addition, the quantity of quantization bits for the feedback angle also affects feedback accuracy. A smaller quantity of quantization bits for the feedback angle indicates lower feedback accuracy, and a larger quantity of quantization bits for the feedback angle indicates higher feedback accuracy. A real wireless channel environment is complex and variable, and a technical solution in a related technology for quantizing a feedback angle based on a quantity of quantization bits for a feedback angle that is specified in a standard is difficult to balance quantization accuracy and quantization overheads.

### SUMMARY

This application provides a wireless communication method and a communications device. The following describes the aspects related to this application.

According to a first aspect, a wireless communication method is provided, and the method includes: transmitting, by a first device, first indication information to a second device, where the first device is a device configured to determine a beamforming feedback angle, and the first indication information is used to indicate a first quantity of quantization bits for the beamforming feedback angle.

According to a second aspect, a wireless communication method is provided, and the method includes: receiving, by a second device, first indication information transmitted by a first device, where the first device is a device configured to determine a beamforming feedback angle, and the first indication information is used to indicate a first quantity of quantization bits for the beamforming feedback angle.

According to a third aspect, a communications device is provided. The communications device is a first device and includes: a transmitting unit, configured to transmit first indication information to a second device, where the first device is a device configured to determine a beamforming feedback angle, and the first indication information is used to indicate a first quantity of quantization bits for the beamforming feedback angle.

According to a fourth aspect, a communications device is provided. The communications device is a second device and includes: a receiving unit, configured to receive first indication information transmitted by a first device, where the first device is a device configured to determine a beamforming feedback angle, and the first indication information is used to indicate a first quantity of quantization bits for the beamforming feedback angle.

According to a fifth aspect, a communications device is provided. The communications device includes a processor and a memory. The memory is configured to store one or more computer programs, and the processor is configured to invoke the computer program in the memory to cause the communications device to perform some or all of the steps of the method according to the first aspect and/or the second aspect.

According to a sixth aspect, an embodiment of this application provides a communications system, and the system includes the foregoing communications device. In another possible design, the system may further include another device that interacts with the communications device in the solutions provided in embodiments of this application.

According to a seventh aspect, an embodiment of this application provides a computer-readable storage medium. The computer-readable storage medium stores a computer program, and the computer program causes a communications device to perform some or all of the steps in a method according to the foregoing aspects.

According to an eighth aspect, an embodiment of this application provides a computer program product. The computer program product includes a non-transitory computer-readable storage medium storing a computer program, and the computer program is operable to cause a communications device to perform some or all of the steps of a method according to the foregoing aspects. In some implementations, the computer program product may be a software installation package.

According to a ninth aspect, an embodiment of this application provides a chip. The chip includes a memory and a processor. The processor may invoke a computer program from the memory and run the computer program, to implement some or all of the steps described in a method according to the foregoing aspects.

### BRIEF DESCRIPTION OF DRAWINGS

FIG. 1 is a schematic diagram of a wireless communications system to which embodiments of this application are applied.

FIG. 2 is an example diagram of an EHT non-TB procedure.

FIG. 3 is an example diagram of a structure of an EHT NDPA frame.

FIG. 4 is an example structural diagram of station information in an EHT NDPA frame.

FIG. 5 is an example diagram of a structure of an EHT NDP frame.

FIG. 6 is an example diagram of an EHT TB channel sounding process.

FIG. 7 is a schematic flowchart of a wireless communication method according to an embodiment of this application.

FIG. 8 is an example structural diagram of station information in an EHT NDPA frame according to an embodiment of this application.

FIG. 9 is an example diagram of a multiple input multiple output control field according to an embodiment of this application.

FIG. 10 is a schematic diagram of a structure of an NDP frame according to an embodiment of this application.

FIG. 11 is a diagram of beamforming feedback angle adaptive quantization schemes classified based on first duration, according to an embodiment of this application.

FIG. 12 is a schematic flowchart of a method according to Embodiment 1 of this application.

FIG. 13 is a schematic flowchart of a method according to Embodiment 2 of this application.

FIG. 14 is a schematic flowchart of a method according to Embodiment 3 of this application.

FIG. 15 is a schematic flowchart of a method according to Embodiment 4 of this application.

FIG. 16 is a schematic structural diagram of a communications device according to an embodiment of this application.

FIG. 17 is a schematic structural diagram of another communications device according to an embodiment of this application.

FIG. 18 is a schematic structural diagram of an apparatus used for communication according to an embodiment of this application.

### DESCRIPTION OF EMBODIMENTS

Technical solutions in this application are described below with reference to the accompanying drawings.

### Communications System

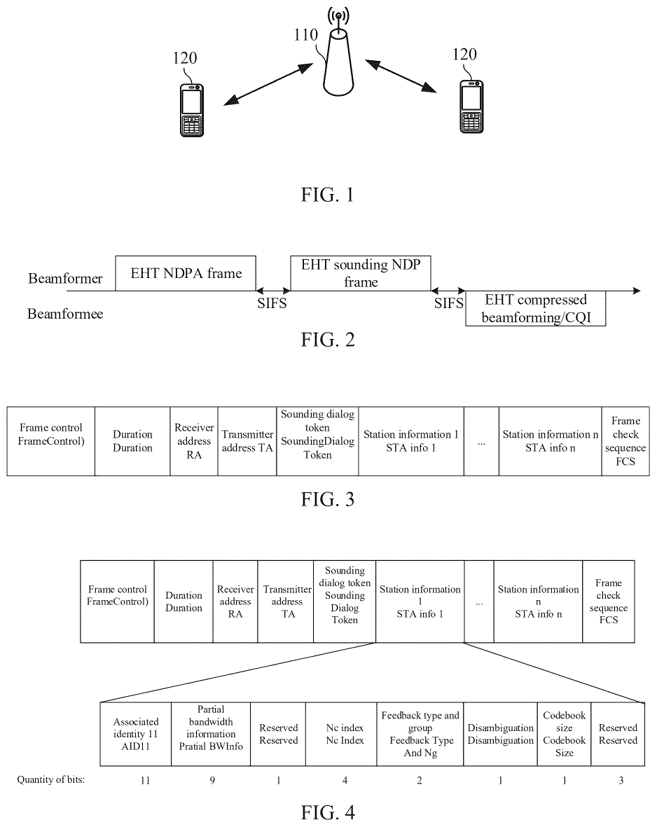

FIG. 1 shows a wireless communications system 100 to which embodiments of this application are applied. The wireless communications system 100 may include an access point (AP) 110 and stations (STA) 120 that access a network via the access point 110.

In some scenarios, an AP is referred to as an AP STA. That is, in a sense, the AP is also a STA.

In some scenarios, a STA is referred to as a non-AP STA (non-AP STA).

Communication in the communications system 100 may be communication between an AP and a STA, or communication between STAs, or communication between a STA and a peer STA. The peer STA may refer to a device that performs peer-to-peer communication with the STA. For example, the peer STA may be an AP, or may be a STA.

An AP is equivalent to a bridge that connects a wired network and a wireless network. A major function of the AP is to connect clients in a wireless network together and then connect the wireless network to an Ethernet. An AP device may be a terminal device (such as a mobile phone) equipped with a wireless fidelity (WiFi) chip, or may be a network device (such as a router).

It should be understood that a role of a STA in a communications system is not absolute. For example, in some scenarios, when a mobile phone is connected to a router, the mobile phone is a STA; and when the mobile phone serves as a hotspot for another mobile phone, the mobile phone serves as an AP.

The AP and the STA may be devices applied in vehicle-to-everything; internet of things nodes, sensors, and the like in internet of things (IoT); intelligent cameras, intelligent remote controls, intelligent water meters, intelligent electricity meters, and the like in smart home; and sensors and the like in smart city.

In some embodiments, both the STA and the AP may support the 802.11be standard. The STA or AP may also support a plurality of current and future wireless local area network (WLAN) standards of an 802.11 family, such as 802.11ax, 802.11ac, 802.11n, 802.11g, 802.11b, and 802.11a.

In embodiments of this application, the STA may be any one of the following that supports the WLAN/Wi-Fi technology: a mobile phone, a tablet computer (Pad), a notebook computer, a palmtop computer, a mobile internet device (MID), a wearable device, a virtual reality (VR) device, an augmented reality (AR) device, a wireless terminal in industrial control, a wireless terminal in self driving, a wireless terminal in remote medical surgery, a wireless terminal in smart grid, a wireless terminal in transportation safety, a wireless terminal in smart city, a wireless terminal in smart home, or the like.

Frequency bands supported in a WLAN technology may include but are not limited to a low frequency band (such as 2.4 GHZ, 5 GHZ, or 6 GHZ) and a high frequency band (for example, 60 GHz).

FIG. 1 exemplarily shows one AP and two STAs. Optionally, the communications system 100 may include a plurality of APs and another quantity of STAs. This is not limited in embodiments of this application.

It should be understood that in embodiments of this application, a device having a communication function in a network or a system may be referred to as a communications device. The communications system 100 shown in FIG. 1 is used as an example. A communications device may include the access point 110 and the stations 120 that have a communication function. The access point 110 and the stations 120 may be specific devices described above. Details are not described herein again. The communications device may further include another device in the communications system 100, such as a network controller, a gateway, or another network entity, which is not limited in embodiments of this application.

The AP and the STA may be deployed on land, including being deployed indoors or outdoors, handheld, or vehicle-mounted, may be deployed on a water surface, or may be deployed on a plane, a balloon, or a satellite in the air. In embodiments of this application, a scenario in which the AP and the STA are located is not limited.

It should be understood that all or some of functions of the communications device in this application may also be implemented by software functions running on hardware, or by virtualization functions instantiated on a platform (for example, a cloud platform).

### Beamforming (Beamforming, BF)

In a beamforming technology, a device that transmits a beamforming frame may be the party that performs beamforming adjustment, that is, a beamformer. A device that receives the beamforming frame may be the party that assists in completing the beamforming adjustment, that is, a beamformee. In a related technology (for example, the institute of electrical and electronics engineers (institute of electrical and electronics engineers, IEEE) 802.11 standards), it is required in a beamforming process that a series of frame transmissions are performed between a beamformer and a beamformee to calculate and feed back a channel matrix. This process is also referred to as a channel sounding (sounding) process.

A channel sounding method may be defined according to a rule regarding whether a trigger frame is required. For example, the channel sounding method may include non-trigger-based (non-TB) channel sounding and trigger-based (TB) channel sounding. The following describes each of the two channel sounding methods by using enhancements for extremely high throughput (EHT) channel sounding as an example.

It should be noted that, the following uses compressed beamforming in IEEE 802.11be (EHT) protocol draft 4.0 as an example for description. However, compressed beamforming is merely an example in this application, and this application may also be applied to other beamforming schemes. In addition, technical solutions involved in this application may also be applied to beamforming technologies in other existing communication standards and future communication standards.

### EHT Non-TB Channel Sounding

EHT non-TB channel sounding refers to a channel sounding method that does not require a trigger frame. FIG. 2 is an example diagram of an EHT non-TB procedure.

As shown in FIG. 2, a beamformer transmits a null data packet announcement (NDPA) frame to notify a beamformee that beamforming is required. FIG. 3 is an example diagram of a structure of an EHT NDPA frame.

Part of parameters related to communication with a STA are specified in a station information (STA Info) field of the NDPA frame, including a feedback type and subcarrier group (Feedback Type And Ng), a codebook size, an Nc index, and the like. FIG. 4 shows a structure of station information in the EHT NDPA frame.

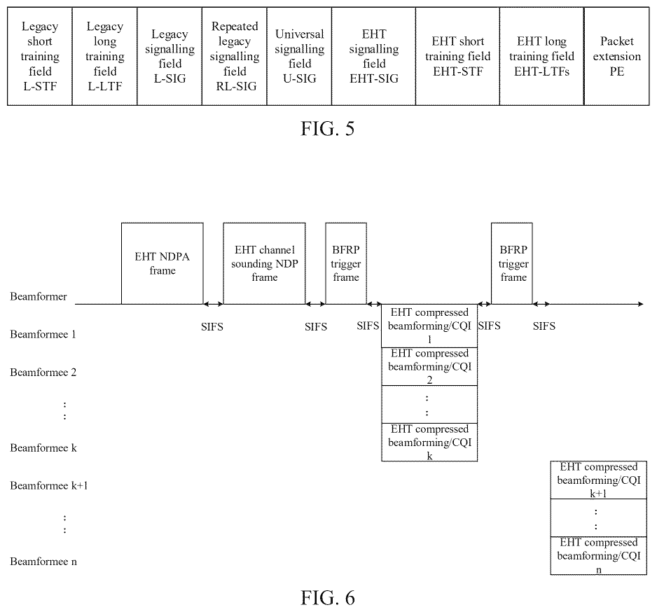

After short interframe space (short interframe space, SIFS), the beamformer transmits a null data packet (null data packet, NDP) frame to the beamformee. FIG. 5 is an example diagram of a structure of an EHT NDP frame.

After receiving the NDP frame, the beamformee performs channel estimation to calculate a channel matrix V. A channel matrix V of each subcarrier may satisfy:

$$V = [ {\prod }_{i = 1}^{min ( {N}_{c} , {N}_{r} - 1 )} [ {D}_{i} ( {1}_{i - 1} {e}^{{j ϕ}_{i , i}} … {e}^{{j ϕ}_{{N}_{r} - 1 , i}} 1 ) ] {\prod }_{l = i + 1}^{{N}_{r}} {G}_{li}^{T} ( {ψ}_{li} ) ] ] {\tilde{I}}_{{N}_{r} \times {N}_{c}} .$$

In which, Dᵢ(1ᵢ₋₁e^{jφ}^{ⱼ} . . . e^{jφ}^{_{N,−1j}} 1) is an Nᵣ×Nᵣ diagonal matrix, and 1ᵢ₋₁ is a sequence of 1s having a length of i−1. Dᵢ(1ᵢ₋₁e^{jφ}^{ⱼ} . . . e^{jφ}^{_{N,−1j}} 1) satisfies:

$${D}_{i} ( {1}_{i - 1} {e}^{{j ϕ}_{i , i}} … {e}^{{j ϕ}_{{N}_{r} - 1 , i}} 1 ) = [ \begin{matrix}{I}_{i - 1} & 0 & … & … & 0 \\ 0 & {e}^{{j ϕ}_{i , i}} & 0 & … & 0 \\ ⋮ & 0 & ⋱ & 0 & 0 \\ ⋮ & ⋮ & 0 & {e}^{{i ϕ}_{{N}_{r} - 1 , i}} & 0 \\ 0 & 0 & 0 & 0 & 1\end{matrix} ] ;$$

and G_{Ii}(ψ) is an Nᵣ×Nᵣ Givens rotation matrix. G_{Ii}(ψ) satisfies:

$${G}_{li} ( ψ ) = [ \begin{matrix}{I}_{i - 1} & 0 & 0 & 0 & 0 \\ 0 & cos ( ψ ) & 0 & sin ( ψ ) & 0 \\ 0 & 0 & {I}_{l - i - 1} & 0 & 0 \\ 0 & - sin ( ψ ) & 0 & cos ( ψ ) & 0 \\ 0 & 0 & 0 & 0 & {I}_{{N}_{r} - 1}\end{matrix} ] .$$

In which, Iₘ is an m×m identity matrix, and Ĩ_{N}_{ᵣ}_{×N}_{ₑ} is an identity matrix. When Nᵣ≠N_{c}, missing rows or columns are padded with zeros.

It may be learned from transformations of the foregoing matrices that the channel matrix V may be expressed by matrix multiplication of Di and G_{Ii}. Di and G_{Ii} are related to two feedback angles Ø and ψ. Therefore, the channel matrix V may be compressed using the two feedback angles Ø and ψ.

After calculating the feedback angles, the beamformee is further required to quantize two feedback angle vectors. Quantities b_{ψ} b_{φ} and of quantization bits for the two angle vectors are indicated in the NDPA frame from the beamformer. A field in the NDPA frame transmitted by the beamformer may be used to indicate the quantities of quantization bits for the feedback angles according to a protocol.

The beamformee quantizes the two feedback angle vectors based on the quantities of quantization bits. Specific quantization calculation of the feedback angle vectors may be shown in Table 1.

TABLE 1

| ψ quantization | φ quantization |
|---|---|
| $ψ = \frac{k π}{{2}^{{b}_{ψ} + 1}} + \frac{π}{{2}^{{b}_{ψ} + 2}} radians ( radians )$ | $ϕ = \frac{k π}{{2}^{{b}_{ϕ} - 1}} + \frac{π}{{2}^{{b}_{ϕ}}} radians ( radians )$ |
| k = 0, 1, ... 2^{b}_{_{ψ}} −1, | k = 0, 1, ... 2^{b}_{_{φ}} −1, |
| where b_{ψ} denotes a quantity | where b_{φ} denotes a quantity |
| of quantization bits for ψ | of quantization bits for φ |

After quantization of the feedback angles is completed, the beamformee places the two quantized feedback angles into a beamforming report (beamfoming report) in a compressed beamforming frame, and transmits the beamforming report to the beamformer. Table 2 shows a format of a compressed beamforming frame.

TABLE 2

| Order (order) | Information (information) |
|---|---|
| 1 | Type (category) |
| 2 | High-throughput action (high-throughput action, |
| | HT action) |
| 3 | Multiple input multiple output control (MIMO |
| | control) |
| 4 | Compressed beamforming report (compressed |
| | beamforming report) |

In Table 2, the channel state information (CSI) compressed beamforming report field is used for transmitting signal-to-noise ratio (SNR) values on space-time streams and beamforming feedback matrices V for different subcarriers. Table 3 shows content of the compressed beamforming report field by using 40 MHz as an example. In Table 3, Nₐ denotes a quantity of quantized angles (number of angles). Each of Ø and Ψ may include one or more angles. Accordingly, Nₐ may be used to denote a total quantity of angles included in Ø and Ψ in a compressed beamforming feedback matrix. Nₐ is typically an even number. For example, a value of Nₐ may be 2, 4, 6, 8, 10, 12, or the like. For example, when Nₐ=2, angles in the compressed beamforming feedback matrix may include Ø11 and Ψ21.

TABLE 3

| Field (field) | Size (size) (in bits) | Meaning (meaning) |
|---|---|---|
| SNR in space-time stream 1 (SNR in | 8 | Average signal-to- |
| space-time stream 1) | | noise ratio in space- |
| | | time stream 1 |
| . . . | . . . | . . . |
| SNR in space-time stream Nc (SNR in | 8 | Average signal-to- |
| space-time stream Nc) | | noise ratio in space- |
| | | time stream Nc |
| Beamforming feedback matrix V for | Nₐ × (b_{ψ} + b_{φ})/2 | Beamforming |
| carrier −58 (Beamforming Feedback | | feedback matrix V |
| Matrix V for carrier −58) | | |
| Beamforming feedback matrix V for | Nₐ × (b_{ψ} + b_{φ})/2 | Beamforming |
| carrier −58 + Ng (Beamforming | | feedback matrix V |
| Feedback Matrix V for carrier −58 + | | |
| Ng) | | |
| . . . | . . . | . . . |
| Beamforming feedback matrix V for | Nₐ × (b_{ψ} + b_{φ})/2 | Beamforming |
| carrier −2 (Beamforming Feedback | | feedback matrix V |
| Matrix V for carrier −2) | | |
| Beamforming feedback matrix V for | Nₐ × (b_{ψ} + b_{φ})/2 | Beamforming |
| carrier 2 (Beamforming Feedback | | feedback matrix V |
| Matrix V for carrier 2) | | |
| Beamforming feedback matrix V for | Nₐ × (b_{ψ} + b_{φ})/2 | Beamforming |
| carrier 2 + Ng (Beamforming Feedback | | feedback matrix V |
| Matrix V for carrier 2 + Ng) | | |
| . . . | . . . | . . . |
| Beamforming feedback matrix V for | Nₐ × (b_{ψ} + b_{φ})/2 | Beamforming |
| carrier 58 (Beamforming Feedback | | feedback matrix V |
| Matrix V for carrier 58) | | |

The beamformer may reconstruct the channel matrix based on the received compressed beamforming frame and a relationship between the matrix V and the two feedback angles Ø and ψ, thereby completing the beamforming process.

### EHT TB Channel Sounding

In EHT TB channel sounding, feedback of a beamforming report is required to be triggered by a beamforming report poll (BFRP) trigger frame. FIG. 6 is an example diagram of an EHT TB channel sounding process.

The EHT TB channel sounding process is generally similar to the EHT non-TB channel sounding process. A difference between the two is that a trigger frame is added during the EHT TB channel sounding process. The trigger frame includes one or more user information fields. Each of the user information fields may identify an EHT beamformee.

Similar to the EHT non-TB channel sounding process, in the EHT TB channel sounding process, quantities of quantization bits for feedback angles may be indicated in an NDPA frame. In EHT TB channel sounding, the quantities of quantization bits for the two feedback angles may be determined based on a feedback type and subcarrier group subfield and a codebook size subfield in the NDPA frame. Correspondences between codes of the two fields and quantities of quantization bits (represented as “quantization resolution” in Table 4) may be as shown in Table 4.

TABLE 4

| Feedback type | | | |
|---|---|---|---|
| and subcarrier | | Codebook | |
| group | | size | |
| B25 | B26 | B28 | Description |
| 0 | 0 | 0 | SU, Ng = 4, quantization resolution (φ, ψ) = {4, 2} |
| 0 | 0 | 1 | SU, Ng = 4, quantization resolution (φ, ψ) = {6, 4} |
| 0 | 1 | 0 | SU, Ng = 16, quantization resolution (φ, ψ) = {4, 2} |
| 0 | 1 | 1 | SU, Ng = 16, quantization resolution (φ, ψ) = {6, 4} |
| 1 | 0 | 0 | MU, Ng = 4, quantization resolution (φ, ψ) = {7, 5} |
| 1 | 0 | 1 | MU, Ng = 4, quantization resolution (φ, ψ) = {9, 7} |
| 1 | 1 | 0 | CQI |
| 1 | 1 | 1 | MU, Ng = 16, quantization resolution (φ, ψ) = {9, 7} |

It should be noted that Table 4 shows only examples of correspondences between codes of two fields (a feedback type and subcarrier group field and a codebook size field) and quantities of quantization bits. Part of the fields in Table 4 and their corresponding descriptions may be implemented separately, or part of the fields in Table 4 may correspond to other descriptions. In other words, content in Table 4 may be split for use, or Table 4 may further include other content. For example, correspondences between quantities of quantization bits, the feedback type and subcarrier group field and the codebook size field may include one or more rows in Table 4. For another example, the “Description” column in Table 4 may include only one or two of a feedback type (SU/MU), Ng, or a quantity of quantization bits. For still another example, the “Description” column in Table 4 may further include other information. The beamformee may quantize the two feedback angle vectors based on Table 1, and transmit the quantized feedback angles to the beamformer by using a beamforming report. After receiving the beamforming report, the beamformer may reconstruct the channel matrix, thereby completing the beamforming process.

It may be learned from the beamforming process that, a quantity of quantization bits for the feedback angle affects feedback overheads in the beamforming process. A larger quantity of quantization bits for the feedback angle indicates greater feedback overheads, and a smaller quantity of quantization bits for the feedback angle indicates lower feedback overheads. As shown in Table 3, a larger quantity of quantization bits indicates a larger size of the field indicating the beamforming feedback matrix in Table 3, and thus indicates greater transmission overheads for the corresponding field. In addition, the quantity of quantization bits for the feedback angle also affects feedback accuracy. A smaller quantity of quantization bits for the feedback angle indicates lower feedback accuracy, and a larger quantity of quantization bits for the feedback angle indicates higher feedback accuracy. A real wireless channel environment is complex and variable, and a technical solution in a related technology for quantizing a feedback angle based on a quantity of quantization bits for a feedback angle that is specified in a standard is difficult to balance quantization accuracy and quantization overheads.

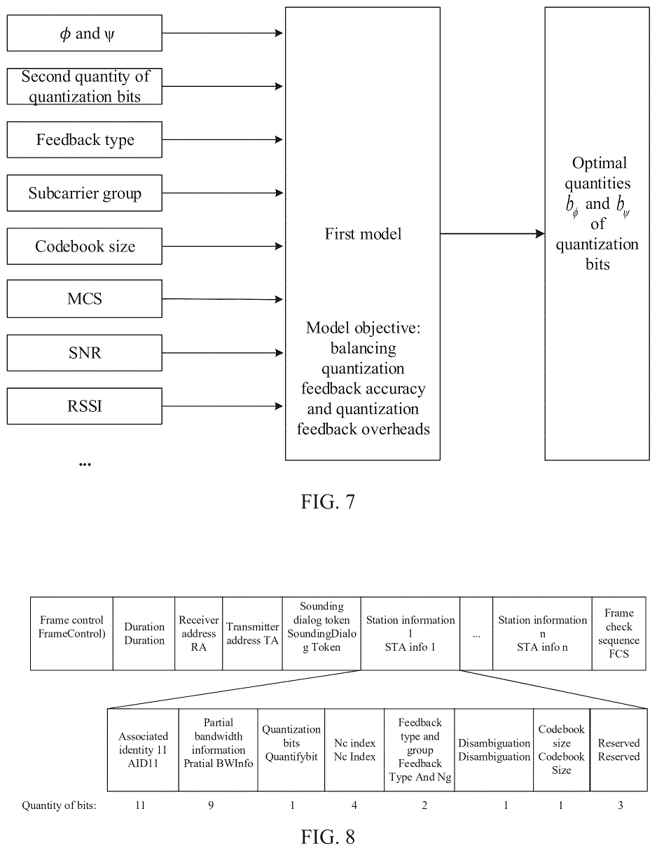

FIG. 7 is a schematic flowchart of a wireless communication method according to an embodiment of this application, to resolve the foregoing problem. The method shown in FIG. 7 may be executed by a first device and a second device. The first device may be a device configured to determine a beamforming feedback angle. For example, the first device may be a beamformee. The second device may be a beamformer.

The method shown in FIG. 7 includes step S710.

In S710, the first device transmits first indication information to the second device.

The first indication information includes compressed information of channel estimation, and the compressed information includes a beamforming feedback angle.

In an embodiment, the first indication information may be used to indicate a first quantity of quantization bits for the beamforming feedback angle. The first quantity of quantization bits may be a quantity of bits determined by the first device for quantizing the feedback angle. The first quantity of quantization bits may include one or more quantities of quantization bits. The number of first quantities of quantization bits may be determined based on a quantity of beamforming feedback angles.

For example, in a case in which there are two beamforming feedback angles, the first quantity of quantization bits may include two quantities of quantization bits. The first quantity of quantization bits may include N bits, first N/2 bits may represent a quantity of quantization bits for one of the feedback angles, and the remaining N/2 bits may represent a quantity of quantization bits for the other feedback angle. N is an integer evenly divisible by 2. For example, the two beamforming feedback angles include φ and ψ. Quantities of quantization bits respectively corresponding to the beamforming feedback angles φ and ψ are denoted as b_{φ} and b_{ψ}, respectively. First N/2 bits of the first quantity of quantization bits may be denoted as b_{φ}, and the remaining N/2 bits of the first quantity of quantization bits may be denoted as b_{ψ}. Alternatively, first N/2 bits of the first quantity of quantization bits may be denoted as by, and the remaining N/2 bits of the first quantity of quantization bits may be denoted as b_{φ}.

Through step S710, the first device may notify the second device of the first quantity of quantization bits by using the first indication information, so that the second device reconstructs a channel matrix based on the first quantity of quantization bits.

It may be learned that, the device that determines the beamforming feedback angle may determine the first quantity of quantization bits. Based on this, the first quantity of quantization bits can be determined more flexibly, thereby achieving a balance between quantization accuracy and quantization overheads, and further improving reliability of a communications system.

It may be understood that, the first quantity of quantization bits achieves a better balance between the quantization accuracy and quantization overheads. Therefore, in some cases, the first quantity of quantization bits may be referred to as an optimal quantity of quantization bits or an optimized quantity of quantization bits.

In some embodiments, the first quantity of quantization bits may be determined based on wireless channel environment information. That is, the first quantity of quantization bits may be flexibly adjusted based on a wireless channel environment. Therefore, even in a complex wireless channel environment, the first quantity of quantization bits may be adaptively adjusted in this application, to implement a balance between the quantization accuracy and quantization overheads.

For example, the first quantity of quantization bits may be determined based on the beamforming feedback angle and/or a communication parameter. The communication parameter may include one or more of the following: a second quantity of quantization bits, a feedback type, a subcarrier group, a codebook size, a modulation and coding scheme (MCS), an SNR, or a received signal strength indicator (receive signal strength indicator, RSSI).

The beamforming feedback angle may include, for example, φ and/or ψ described above. The first device may perform channel estimation to calculate the beamforming feedback angle.

The second quantity of quantization bits may be indicated in an NDPA frame. For example, the second quantity of quantization bits may be determined based on a feedback type and subcarrier group subfield and a codebook size subfield in the NDPA frame. Correspondences between codes of the two fields and the second quantity of quantization bits may be as shown in part or all of rows/columns in Table 4. The second quantity of quantization bits may be represented by quantization resolution in Table 4.

The second quantity of quantization bits is described below with reference to Table 4. For example, in a case in which B25 and B26 corresponding to the feedback type and subcarrier group field are respectively 0 and 0, and B28 corresponding to the codebook size field is 0, quantities of quantization bits for φ and ψ included in the second quantity of quantization bits may be 4 and 2, respectively. For another example, in a case in which B25 and B26 corresponding to the feedback type and subcarrier group field are respectively 1 and 0, and B28 corresponding to the codebook size field is 0, quantities of quantization bits for φ and ψ included in the second quantity of quantization bits may be 7 and 5, respectively. The feedback type may include: single user (SU) or multi user (MU).

The feedback type and/or subcarrier group may be indicated in an NDPA frame. For example, the feedback type and/or subcarrier group may be indicated in a feedback type and subcarrier group field in the NDPA frame.

The codebook size may be indicated in an NDPA frame. For example, the codebook size may be indicated in a codebook (codebook) field in the NDPA frame.

In a case in which TB channel sounding is performed, the foregoing communication parameter may include the MCS. That is, in the TB channel sounding process, the first quantity of quantization bits may be determined based on the MCS. The MCS may be indicated in a trigger frame. For example, the MCS may be indicated in an uplink (UL) enhancements for extremely high throughput modulation and coding scheme (UL-EHT MCS) subfield in an EHT variant user information (variant user info) field in a BFRP trigger frame.

The SNR may be calculated by the first device by channel estimation. For example, the SNR may be obtained by averaging calculated SNRs of all subcarriers.

The RSSI may be obtained by the first device through measurement. For example, the first device may learn the RSSI by measuring a power value on a current receive antenna by using an enhancement for extremely high throughput long training field (EHT long training field, EHT-LTF).

It should be noted that the first quantity of quantization bits may alternatively be determined based on other information. This is not limited in this application.

In some embodiments, the first quantity of quantization bits may be determined by using a first model. As shown in FIG. 7, one or more of the beamforming feedback angle, the second quantity of quantization bits, the feedback type, the subcarrier group, the codebook size, the MCS, the SNR, or the RSSI may be used as an input to the first model. The first model may output the first quantity of quantization bits.

Since the first model may implement adaptive adjustment of the first quantity of quantization bits, the first model may also be referred to as a beamforming feedback angle adaptive quantization model.

In some embodiments, the first model may be an artificial intelligence (artificial intelligence, AI) model. For example, the first model may be an artificial intelligence and machine learning (AIML) model. Alternatively, the first model may be another type of model. For example, the first model may be a rule-based model.

In a case in which the first model is an AI model, before inference is performed using the first model (that is, determining the first quantity of quantization bits), the first model may be trained (that is, a learning process of the first model is performed). The AI model may learn the beamforming feedback angle and/or the communication parameter, and obtain an optimized quantity of quantization bits for a feedback angle vector, with an objective of balancing quantization overheads and the quantization accuracy of the feedback angle vector.

Training of the first model may be completed by the first device and/or the second device. For example, the first model may be trained by the first device. The first device may train the first model based on a local resource or information. Alternatively, the first model may be trained by the second device. If inference of the first model is performed on the first device, the second device may transmit a trained model parameter to the first device.

In some embodiments, the first device may receive second indication information transmitted by the second device.

The second indication information may be used to indicate whether the first device is required to determine the first quantity of quantization bits. Alternatively, the second indication information may be used to indicate whether the feedback angle is required to be quantized based on the first quantity of quantization bits. That is, the second indication information may indicate a determining method, a calculation method, or a decision result of the quantity of quantization bits. For example, the second indication information may indicate: quantizing the feedback angle by using the first quantity of quantization bits, quantizing the feedback angle by using the second quantity of quantization bits, or quantizing the feedback angle without using the second quantity of quantization bits. Accordingly, the second indication information may also be referred to as decision result information of the quantity of quantization bits.

The first device may determine, based on indication of the second indication information, whether to determine the first quantity of quantization bits or whether to quantize the feedback angle based on the first quantity of quantization bits. If the first device is required to determine the first quantity of quantization bits, the first device may quantize the feedback angle based on the first quantity of quantization bits. If the first device is not required to determine the first quantity of quantization bits, the first device may quantize the feedback angle based on the second quantity of quantization bits.

It may be understood that the second device may intervene in behavior of the first device by using the second indication information, thereby correcting in a timely manner any potential anomalies that may occur during a quantization process of the feedback angle. For example, if the second device detects an anomaly in the first quantity of quantization bits, the feedback angle, or transmission, the second device may instruct the first device not to determine the first quantity of quantization bits, or may instruct the first device to quantize the feedback angle by using the second quantity of quantization bits.

In some embodiments, before each channel sounding operation, the second device may transmit the second indication information to the first device to ensure controllability of the quantization process of the feedback angle.

Optionally, the first device may alternatively independently decide whether to determine the first quantity of quantization bits or whether to quantize the feedback angle based on the first quantity of quantization bits. For example, during an initial sounding, the first device is required to quantize the feedback angle by using the second quantity of quantization bits.

In some cases, the first device may be required to determine the first quantity of quantization bits by default. In other words, by default, the first device is required to determine the first quantity of quantization bits or required to quantize the feedback angle based on the first quantity of quantization bits. The first device is not required to determine the first quantity of quantization bits in the following cases: initial sounding or an SNR of a historical transmission (for example, a previous transmission, that is, a last transmission) is lower than a first threshold. For example, when the second device detects that an SNR of a previous transmission is lower than a threshold, the second device may instruct, by using the second indication information, the first device not to determine the first quantity of quantization bits. Alternatively, when the second device detects that a current sounding operation is an initial sounding operation, the second device may instruct, by using the second indication information, the first device not to determine the first quantity of quantization bits.

The second indication information may be indicated in a first bit. In other words, a field including the second indication information may occupy one bit. For example, in a case in which the first bit is 0, the first device is required to determine the first quantity of quantization bits or required to quantize the feedback angle based on the first quantity of quantization bits. In a case in which the first bit is 1, the first device is not required to determine the first quantity of quantization bits or is required to quantize the feedback angle based on the second quantity of quantization bits. Alternatively, in a case in which the first bit is 1, the first device is required to determine the first quantity of quantization bits or required to quantize the feedback angle based on the first quantity of quantization bits. In a case in which the first bit is 0, the first device is not required to determine the first quantity of quantization bits or is required to quantize the feedback angle based on the second quantity of quantization bits.

It should be noted that, in a case in which the second indication information indicates that the first device is required to determine the first quantity of quantization bits or is required to quantize the feedback angle based on the first quantity of quantization bits, the second indication information may include that the first device is not required to parse or acquire the second quantity of quantization bits or that the first device is not required to quantize the feedback angle based on the second quantity of quantization bits. Such an indication manner does not expose a capability of the first device to determine the first quantity of quantization bits. For example, the first model is an AI model. Such an indication manner may not expose an AI capability of the first device.

The second indication information may be carried in an NDPA frame. For example, the second indication information may be carried in a first field in the NDPA frame. The first field may be a newly added field in the NDPA frame or may reuse an existing field in the NDPA frame. The first field may also be referred to as a quantization bit (quantify bit) field.

In some embodiments, the first field may be a reserved field redefined in a STA Info field. As shown in FIG. 8, the reserved field at bit B20 in the STA Info field is redefined as a quantization bit field.

In some embodiments, in a case in which the second indication information is carried in the first field in the NDPA frame, at least one of a feedback type and subcarrier group field or a codebook size field in the NDPA frame may be set as a reserved field. In other words, if the first device parses the first field, the first device may skip parsing the feedback type and subcarrier group field and/or the codebook size field.

In a possible implementation, the first indication information may be carried in a first information field in a beamforming report. The first information field may be, for example, a multiple input multiple output control (MIMO control) field.

The first indication information may be carried in a second field. The second field may be, for example, a newly added field in the multiple input multiple output control field.

In some embodiments, a length of the second field may be M bits. M may be an integer greater than 0. For example, M may be equal to 6 or 8. For example, the first quantity of quantization bits includes quantities b_{φ} and b_{ψ} of quantization bits for two feedback angles. In this case, the length of the second field may be eight bits. b_{φ} and b_{ψ} may occupy the first 4 bits and the last 4 bits, respectively. b_{φ} and b_{ψ} are respectively used to indicate quantities of quantization bits for φ and ψ. FIG. 9 is an example diagram of the multiple input multiple output control field including the added second field. In FIG. 9, the second field is represented by quantities of quantization bits for φ and ψ (φ and ψ Quantify bits).

In some embodiments, the length of the second field may be 0. For example, in a case in which the first device does not determine the first quantity of quantization bits, or the first device quantizes the feedback angle by using the second quantity of quantization bits, the length of the second field may be 0.

In some embodiments, in response to receiving the first frame or a second frame, the first device may transmit the first indication information to the second device. The first frame is transmitted by the second device to the first device. The first frame may be used to determine the beamforming feedback angle. The second frame may be later than the first frame.

It may be understood that, the technical solution in which the first device transmits the first indication information to the second device in response to receiving the first frame may be implemented as follows. The first device may immediately determine the first quantity of quantization bits based on the beamforming feedback angle after determining the beamforming feedback angle based on the first frame, and quantize the feedback angle by using the first quantity of quantization bits. After receiving the first frame, the first device may transmit the first indication information in a current channel sounding process.

The second frame may be a trigger frame for measuring the beamforming feedback angle. For example, the second frame may be a BFRP trigger frame. In this case, the technical solution in which the first device transmits the first indication information to the second device in response to receiving the second frame may be implemented as follows. The first device may immediately determine the first quantity of quantization bits based on the beamforming feedback angle after determining the beamforming feedback angle based on the first frame, and quantize the feedback angle by using the first quantity of quantization bits. After receiving the trigger frame, the first device may transmit the first indication information.

The second frame may be a frame, after the first frame, used for determining the feedback angle; or may be a trigger frame, after the first frame, corresponding to a frame used for determining the feedback angle. In other words, the first frame may be a frame historically (for example, last time) used to determine the beamforming feedback angle. For example, the first device may perform the following steps: determining a historical feedback angle in advance based on a frame historically used for determining the feedback angle; determining the first quantity of quantization bits based on the historical feedback angle during a current beamforming process; and quantizing the feedback angle determined during the current beamforming process based on the first quantity of quantization bits.

In some embodiments, the first frame used to determine the feedback angle may be an NDP frame. In some embodiments, the first frame used to determine the feedback angle may be an NDPA frame. For example, the first device may perform channel estimation based on one or more of the following fields in a physical layer protocol data unit (PPDU) that carries the NDPA frame: a high-efficiency (HE) field, an EHT field, or an ultra-high reliability long training field (UHR-LTF) field.

It may be understood that, in a case in which the first frame is an NDPA frame, compared with a case in which the first frame is an NDP frame, the first device may determine the feedback angle earlier, so as to start earlier to determine the first quantity of quantization bits, thereby providing more time for determining the first quantity of quantization bits.

In some embodiments, a padding may be added to provide more time for the first device to determine the first quantity of quantization bits. For example, if calculation time for determining the first quantity of quantization bits by using the first model is T, and when T is slightly greater than SIFS duration, the first device may not have determined the first quantity of quantization bits when the SIFS duration expires, resulting in that the first device is unable to quantize the feedback angles and also is unable to transmit the first indication information. adding the padding may cause duration that can be used for calculating the first quantity of quantization bits to be longer than the SIFS duration. Therefore, the first device may complete determining the first quantity of quantization bits before the SIFS duration expires, thereby quantizing the feedback angle and transmitting the first indication information.

Optionally, the first frame may include a padding field. For example, during non-TB channel sounding, the first frame may include a padding field. Maximum duration of the padding field may be T_{PE,max}us. T_{PE,max} may be a number greater than 0. Content of the padding field may be arbitrary. The padding field should be transmitted using average transmit power of a bandwidth of the first frame. The padding field may be located at the end of the first frame.

It should be noted that the padding field may be a newly added field or an existing field in the first frame. For example, the padding field may include a packet extension (packet extension, PE) field. The second device may add a padding to the PE field.

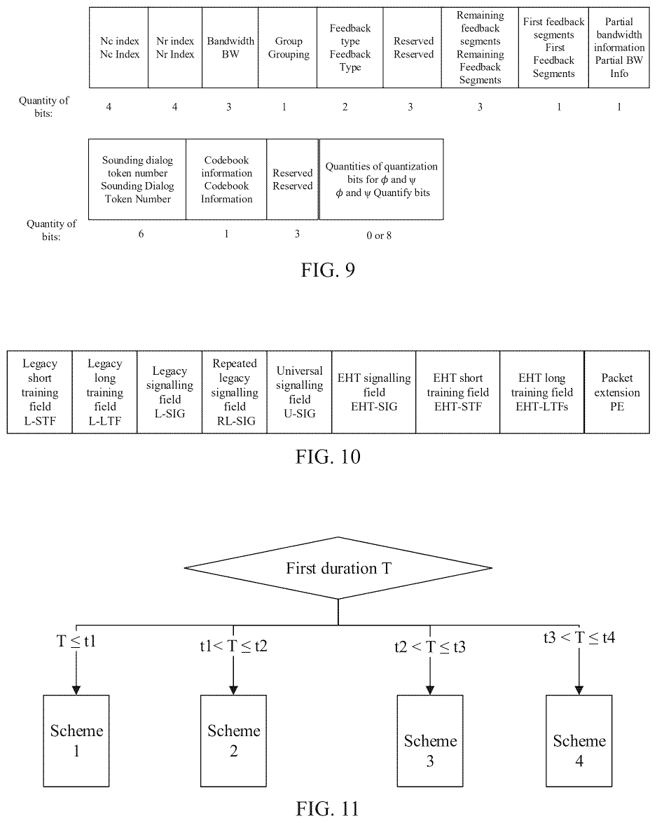

FIG. 10 shows a structure of a UHR NDP frame that includes a padding field, by using an example in which the first frame is an ultra-high reliability (UHR) NDP frame. In FIG. 10, the padding field is a PE field.

In some embodiments, in a case in which the second frame is a trigger frame, that is, in a TB channel sounding process, the trigger frame may include a medium access control (MAC) padding. A quantity of bits of the MAC padding L_{PAD,MAC} may satisfy:

$${L}_{PAD , MAC} = {N}_{DBPS} \times ⌈ \frac{{T}_{min}}{{T}_{SYM}} ⌉ ,$$

where N_{DBPS} denotes a quantity of data bits per each orthogonal frequency division multiple access (OFDM) symbol (data bits per OFDM symbol); T_{SYM} denotes duration corresponding to one OFDM symbol; and Tₘᵢₙ denotes minimum trigger frame processing duration required by the first device. Tₘᵢₙ may depend on whether the first device determines the first quantity of quantization bits.

In some embodiments, a beamforming feedback angle adaptive quantization scheme may be determined based on first duration. The first duration may be processing duration for determining the first quantity of quantization bits. Within the first duration, the first device may complete calculation or inference of the first quantity of quantization bits. In a case in which the first model is an AI model, the first duration may be inference duration of the AI model.

The beamforming feedback angle adaptive quantization scheme may be related to a frame to which the first indication information responds or may be related to a padding. For example, the frame in response to which the first indication information is transmitted is determined based on the first duration. In other words, the first device may determine, based on the first duration, the frame in response to which the first indication information is transmitted. Alternatively, the first device may determine, based on the first duration, whether to add a padding field to the first frame, whether to add a MAC padding to the trigger frame, or determine padding duration.

Due to factors such as software and hardware differences between different devices and an algorithm of the first model, the first duration varies depending on different devices. The beamforming feedback angle adaptive quantization scheme is determined based on the first duration, so that the first model can be more properly applied to the beamforming feedback angle quantization process, that is, the beamforming feedback angle quantization process may be better coordinated with the inference process of the first model.

For example, different types of beamforming feedback angle adaptive quantization schemes may be used depending on the first duration T.

In some embodiments, the first duration may be classified into four intervals based on a first threshold t1, a second threshold t2, a third threshold t3, and a fourth threshold t4, and different intervals may correspond to different feedback angle quantization schemes. In which, t1 is less than the SIFS duration, for example, t1=16 μs; t2 is slightly greater than the SIFS duration, for example, t2=30 μs; t3 approximates NDP duration, for example, t3=200 μs; t4 approximates duration of one sounding operation, for example, t4=500 μs.

FIG. 11 is a diagram of beamforming feedback angle adaptive quantization schemes classified based on the first duration T. In a case in which the first model is an AIML model, Table 5 provides an overview of a feedback angle quantization scheme corresponding to FIG. 11.

TABLE 5

| Scheme | First | |
|---|---|---|
| number | duration T | Overview of the feedback angle quantization scheme |
| 1 | T ≤ t1 us | Performing immediate inference using the AIML |
| | | model after obtaining an angle vector by using an NDP |
| | | (performing immediate AIML inference by using the |
| | | NDP) |
| 2 | t1 us < T ≤ t2 | Performing immediate inference using the AIML |
| | us | model after obtaining an angle vector by using an NDP |
| | | (performing immediate AIML inference by using the |
| | | NDP, while a padding is required to be added to the |
| | | NDP to provide more time) |
| 3 | t2 us < T ≤ t3 | Obtaining a feedback angle vector from an |
| | us | HE/EHT/UHR-LTF field in a PPDU that carries an |
| | | NDPA frame and performing AIML model inference |
| | | in advance (using an earlier NDPA may provide more |
| | | time for the AIML model) |
| 4 | t3 us < T ≤ t4 | Performing inference before each sounding operation |
| | us | by using a feedback angle obtained in a previous |
| | | sounding operation (performing AIML inference prior |
| | | to sounding) |

The following describes the four schemes in Table 5 separately with reference to Embodiment 1 to Embodiment 4 by using an example in which the first model is an AIML model.

### Embodiment 1

Embodiment 1 describes a technical solution for a case in which inference duration of the AIML model is less than t1.

First, the beamformer decides a method for calculating a quantity of quantization bits. Then, the beamformer transmits an NDPA to the beamformee. One bit is added to the NDPA to indicate a decision result of the quantity of quantization bits. After receiving the NDPA, the beamformee may check the decision result of the quantity of quantization bits. The beamformer transmits an NDP. The beamformee performs channel estimation based on the NDP, and calculates feedback angle vectors φ and ψ. If the beamformer decides that the beamformee is to calculate the quantity of quantization bits by using the AIML, the beamformee calculates the quantity of quantization bits by using the AIML, so as to obtain the first quantity of quantization bits. The beamformee quantizes φ and ψ based on the first quantity of quantization bits calculated by using the AIML. The beamformee feeds back a beamforming report. The beamforming report carries optimal quantities of quantization bits for the two feedback angle vectors. The beamformer receives the beamforming report, and can restore a channel matrix based on the quantized ¢ and w and the first quantity of quantization bits.

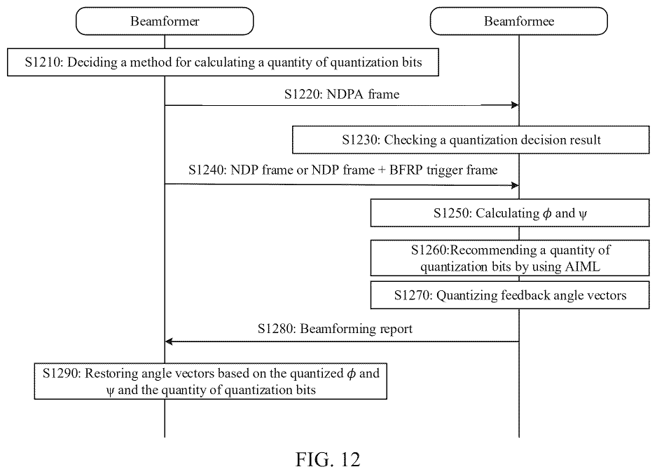

FIG. 12 is a schematic flowchart of the method according to Embodiment 1. The method shown in FIG. 12 may be performed by a beamformer and a beamformee. The method shown in FIG. 12 may include steps S1210 to S1290.

In step S1210, the beamformer decides a method for calculating a quantity of quantization bits.

The beamformee recommends the first quantity of quantization bits by default. If initial sounding is performed or if the beamformer detects that an SNR of a previous (last) transmission is less than a threshold, the beamformer decides that the quantity of quantization bits is the second quantity of quantization bits indicated by a protocol in an NDPA frame.

In step S1220, the beamformer transmits an NDPA frame.

The NDPA frame includes a bit that is used to indicate a decision result of the quantity of quantization bits.

As shown in FIG. 8, the reserved field at bit B20 in the STA Info field in the NDPA may be redefined as a quantization bit field. This field occupies one bit, and is used to indicate the decision result of the quantity of quantization bits. If the quantization bit field is 1, the beamformee performs quantization based on the second quantity of quantization bits indicated in the NDPA. If the quantization bit field is 0, an AIML model in the beamformee calculates the first quantity of quantization bits, and the UHR beamformee may set the feedback type and subcarrier group field and the codebook size field as reserved fields.

In step S1230, the beamformee checks the decision result of the quantity of quantization bits in the NDPA.

The beamformee checks the quantization bit field in the NDPA. If the quantization bit field is 1, the beamformee performs quantization based on the second quantity of quantization bits indicated in the NDPA. If the quantization bit field is 0, the AIML model in the beamformee calculates the first quantity of quantization bits. Alternatively, if the quantization bit field is 0, it may indicate that the beamformee performs quantization based on a quantity of quantization bits indicated in a non-NDPA, thereby avoiding exposing an AIML capability of the beamformee. In addition, if the quantization bit field indicates 0, the UHR beamformee may set the feedback type and subcarrier group field and the codebook size field as reserved fields.

In step S1240, the beamformer transmits an NDP, or the beamformer transmits an NDP and a BFRP trigger frame.

In step S1250, the beamformee calculates feedback angle vectors φ and.

In step S1260, if the beamformer decides that the beamformee is to calculate the quantity of quantization bits by using the AIML, an optimal quantity of quantization bits is calculated based on current φ and ψ, a feedback type, a subcarrier group Ng, a codebook size, an MCS, an SNR, an RSSI, a historical quantity of quantization bits, or other related communication parameter information.

In step S1270, the beamformee quantizes φ and ψ based on the quantity of quantization bits calculated by using the AIML.

In step S1280, the beamformee feeds back a beamforming report.

A field is newly added to a MIMO control field in a compressed beamforming frame, to indicate the first quantity of quantization bits, that is, quantities b_{φ} and b_{ψ} of quantization bits for the two feedback angle vectors. For example, the newly added field may be a φ and ψ quantization bit quantity subfield.

FIG. 9 shows the φ and ψ quantization bit quantity subfield of eight bits that indicates the quantities b_{φ} and b_{ψ} of quantization bits and is added to a multiple input multiple output control field. b_{φ} and b_{ψ} respectively occupy first four bits and the remaining four bits, which are respectively used to indicate adaptive quantities of quantization bits for φ and ψ. If the NDPA indicates that the quantity of quantization bits is the second quantity of quantization bits defined in a standard, this field may not exist.

In step S1290, the beamformer receives the compressed beamforming frame, and restores the angle vectors based on the quantized φ and ψ and the quantity of quantization bits.

In this solution, inference duration of the AIML model is relatively short. Therefore, upon obtaining a latest feedback angle vector, immediate inference by using the AIML model may be performed to calculate the optimal quantity of quantization bits.

### Embodiment 2

Embodiment 2 describes a technical solution for a case in which inference duration of the AIML model is between t1 and t2.

First, the beamformer decides a method for calculating a quantity of quantization bits. Then, the beamformer transmits an NDPA frame to the beamformee. One bit is added to the NDPA to indicate a decision result of the quantity of quantization bits. After receiving the NDPA frame, the beamformee may check the decision result of the quantity of quantization bits. If a non-TB channel sounding procedure is performed, the beamformer transmits an NDP, where a padding is required to be added to the NDP to provide more time for inference using the AIML model. If a TB channel sounding procedure is performed, the beamformer adds a MAC padding to a BFRP trigger frame. The beamformee performs channel estimation based on the NDP, and calculates feedback angle vectors φ and ψ. If the beamformer decides that the beamformee is to calculate the quantity of quantization bits by using the AIML, the beamformee calculates the quantity of quantization bits by using the AIML. The beamformee quantizes φ and ψ based on the quantity of quantization bits calculated by using the AIML. The beamformee feeds back a beamforming report. The beamforming report carries optimal quantities of quantization bits for the two feedback angle vectors. The beamformer receives the beamforming report, and can restore a channel matrix based on the quantized φ and ψ and the first quantity of quantization bits.

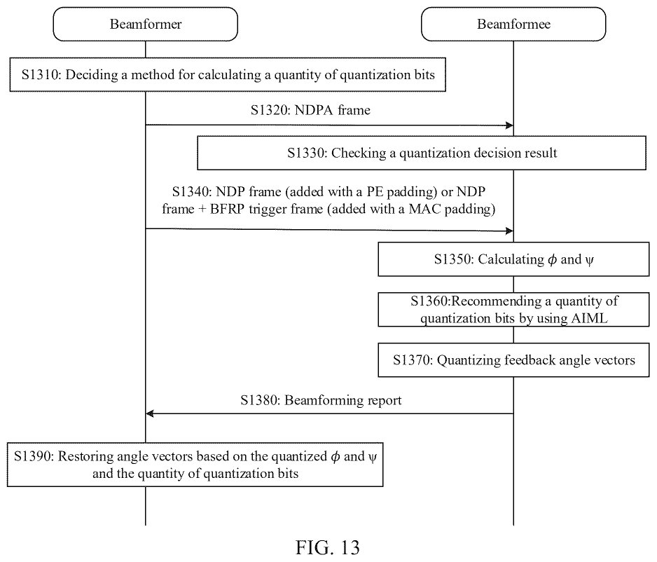

FIG. 13 is a schematic flowchart of the method according to Embodiment 2. The method shown in FIG. 13 may be performed by a beamformer and a beamformee. The method shown in FIG. 13 may include steps S1310 to S1390.

In step S1310, the beamformer decides a method for calculating the quantity of quantization bits: the quantity of quantization bits is recommended by the beamformee by default; but if initial sounding is performed or the beamformer detects that an SNR of a previous (last) transmission is less than a threshold, the quantity of quantization bits may be indicated in an NDPA frame according to a protocol.

In step S1320, the beamformer transmits an NDPA frame. One bit is added to the NDPA frame to indicate a decision result of the quantity of quantization bits. This is the same as Embodiment 1.

In step S1330, the beamformee checks the decision result of the quantity of quantization bits in the NDPA frame. The quantization bit field in the NDPA frame is checked. This process is similar to step S1230.

In step S1340, the beamformer transmits an NDP frame, or the beamformer transmits an NDP frame and a BFRP trigger frame.

If non-TB channel sounding is performed, the beamformer transmits an NDP frame. Maximum duration of a PE field in the UHR NDP frame is T_{PE,max}, for example 20 us, thereby providing more time for AIML operations. Content of the padding may be arbitrary, and the PE field should be transmitted using average transmit power of a bandwidth of the NDP. FIG. 10 is an example diagram of a structure of an UHR NDP frame.

If TB channel sounding is performed, the beamformer adds a MAC padding to the BFRP trigger frame. A quantity of padded bits is calculated as follows:

$${L}_{PAD , MAC} = {N}_{DBPS} \times ⌈ \frac{MinTrigProcTime}{{T}_{SYM}} ⌉ .$$

N_{DBPS} denotes a quantity of data bits per each OFDM symbol; T_{SYM} denotes duration corresponding to each OFDM symbol; minimum trigger frame processing duration (that is, MinTrigProcTime) required by a STA depends on whether the STA executes a process of determining the quantity of quantization bits through AIML inference.

In step S1350, the beamformee calculates feedback angle vectors φ and v.

In step S1360, if the beamformer decides that the beamformee is to calculate the quantity of quantization bits by using the AIML, an optimal quantity of quantization bits is calculated based on current φ and ψ, a feedback type (SU/MU), a subcarrier group Ng, a codebook size, an MCS, an SNR, an RSSI, a historical quantity of quantization bits, or other related communication parameter information.

In step S1370, the beamformee quantizes φ and ψ based on the quantity of quantization bits calculated by using the AIML model.

In step S1380, the beamformee feeds back a beamforming report, that is, adds a new field to a multiple input multiple output control field in a compressed beamforming frame to indicate quantities b_{φ} and b_{ψ} of quantization bits for the two feedback angle vectors, for example, a φ and ψ quantization bit quantity subfield, which is the same as Embodiment 1.

In step S1390, the beamformer receives the beamforming report, and restores angle vectors based on the quantized φ and, and the quantity of quantization bits.

In Embodiment 2, inference duration of the AIML model is between t1 and t2. Therefore, it is possible to consider adding a padding to a PE field in an NDP or adding a MAC padding to a BFRP trigger frame to provide more time for the AIML inference process. Similar to Embodiment 1, this solution also supports immediate AIML inference.

### Embodiment 3

Embodiment 3 describes a technical solution for a case in which inference duration of the AIML model is between t2 and t3.

The beamformee may perform channel estimation in advance by using an HE/EHT/UHR-LTF field in a PPDU that carries an NDPA frame, calculates a feedback angle, and transmits the feedback angle estimated using the NDPA to the AIML model, so as to calculate an optimal quantity of quantization bits in advance.

First, the beamformer decides a method for calculating a quantity of quantization bits. Then, the beamformer transmits an NDPA to the beamformee. One bit is added to the NDPA to indicate a decision result of the quantity of quantization bits. After receiving the NDPA, the beamformee may check the decision result of the quantity of quantization bits. The beamformee performs channel estimation based on the HE/EHT/UHR-LTF field in the PPDU that carries the NDPA frame, and calculates φ and ψ. If the beamformer decides that the beamformee is to calculate the quantity of quantization bits by using the AIML, the beamformee calculates the quantity of quantization bits by using the AIML. The beamformee quantizes φ and ψ based on the quantity of quantization bits calculated by using the AIML. The beamformer transmits an NDP. The beamformee feeds back a beamforming report. The beamforming report carries optimal quantities of quantization bits for the two feedback angle vectors. The beamformer receives the beamforming report, and can restore a channel matrix based on the quantized φ and ψ and the first quantity of quantization bits.

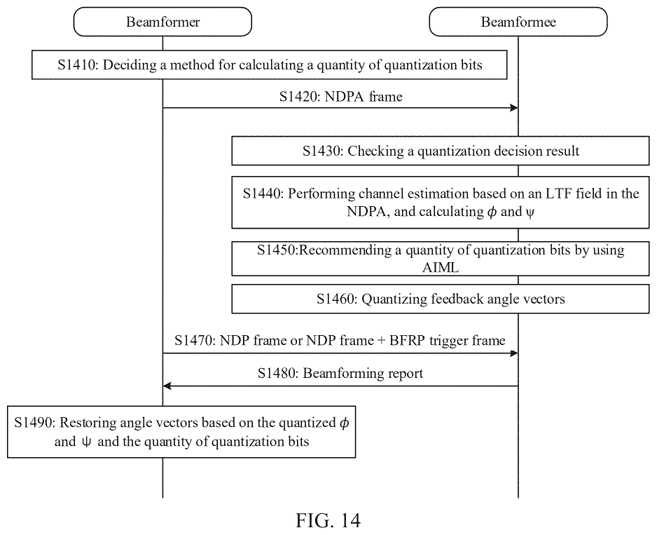

FIG. 14 describes a schematic flowchart of the method according to Embodiment 3. The method shown in FIG. 14 may be performed by a beamformer and a beamformee. The method shown in FIG. 14 may include steps S1410 to S1490.

In step S1410, the beamformer decides a method for calculating the quantity of quantization bits: the quantity of quantization bits is recommended by the beamformee by default; but if initial sounding is performed or the beamformer detects that an SNR of a previous (last) transmission is less than a threshold, the quantity of quantization bits is indicated in an NDPA frame according to a protocol.

In step S1420, the beamformer transmits an NDPA frame. One bit is added to the NDPA frame to indicate a decision result of the quantity of quantization bits. This is the same as Embodiment 1.

In step S1430, the beamformee checks the decision result of the quantity of quantization bits in the NDPA. The beamformee checks the quantization bit field in the NDPA. The step S1430 is similar to the step S1230.

In step S1440, the beamformee performs channel estimation based on the HE/EHT/UHR-LTF field in the PPDU that carries the NDPA frame, and calculates φ and y.

In step S1450, the beamformer decides that the beamformee is to calculate the quantity of quantization bits by using the AIML. The beamformee calculates an optimal quantity of quantization bits based on current φ and ψ, a feedback type (SU/MU), a subcarrier group Ng, a codebook size, an MCS, an SNR, an RSSI, a historical quantity of quantization bits, or other related communication parameter information.

In step S1460, the beamformee quantizes ¢ and ψ based on the quantity of quantization bits.

In step S1470, the beamformer transmits an NDP frame, or transmits an NDP frame and a BFRP trigger frame.

In step S1480, the beamformee feeds back a beamforming report. A new field is added to a multiple input multiple output control field in a compressed beamforming frame to indicate quantities b_{φ} and b_{ψ} of quantization bits for the two feedback angle vectors, for example, a φ and ψ quantization bit quantity subfield, which is the same as Embodiment 1.

In step S1490, the beamformer receives the beamforming report, and restores angle vectors based on the quantized φ and y, and the quantity of quantization bits.

Since processing time of the AIML model is at a level of duration of an NDP frame, to provide more calculation time for the AIML model, channel estimation may be performed in advance by using the NDPA frame, to obtain an angle vector; and the beamformee may immediately perform AIML operations upon receiving the NDPA frame.

### Embodiment 4

When inference duration of the AIML model is relatively long and reaches a level of a sounding period t4, a previous feedback angle may be used to calculate an optimal quantity of quantization bits in advance.

First, the beamformer decides a method for calculating a quantity of quantization bits. The beamformee should also calculate the quantity of quantization bits in advance by using the AIML. Then, the beamformer transmits an NDPA frame to the beamformee, where one bit is added to the NDPA frame to indicate a decision result of the quantity of quantization bits. After receiving the NDPA frame, the beamformee may check the decision result of the quantity of quantization bits. The beamformer transmits an NDP frame. The beamformee performs channel estimation based on the NDP frame, and calculates feedback angle vectors φ and ψ. If the beamformer decides that the beamformee is to calculate the quantity of quantization bits by using the AIML, the beamformee quantizes φ and ψ based on the optimal quantity of quantization bits calculated by using the AIML. The beamformee feeds back a beamforming report. The beamforming report carries optimal quantities of quantization bits for the two feedback angle vectors. The beamformer receives the beamforming report, and can restore a channel matrix based on the quantized φ and ψ and the first quantity of quantization bits.

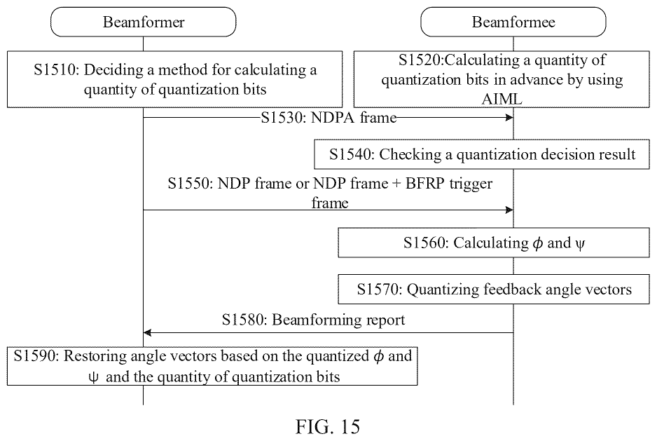

FIG. 15 is a schematic flowchart of the method according to Embodiment 4. The method shown in FIG. 15 may be performed by a beamformer and a beamformee. The method shown in FIG. 15 may include steps S1510 to S1580.

In step S1510, the beamformer decides a method for calculating a quantity of quantization bits. The quantity of quantization bits is recommended by the beamformee by default; but if initial sounding is performed or the beamformer detects that an SNR of a previous (last) transmission is less than a threshold, the quantity of quantization bits is indicated in an NDPA frame according to a protocol.

In step S1520, the beamformee calculates the quantity of quantization bits in advance. The beamformee calculates an optimal quantity of quantization bits based on previous ¢ and y, a feedback type (SU/MU), a subcarrier group Ng, a codebook size, an MCS, an SNR, an RSSI, a historical quantity of quantization bits, or other related communication parameter information, and stores the optimal quantity of quantization bits for quantizing @ and ψ in the next sounding.

In step S1530, the beamformer transmits an NDPA frame. One bit is added to the NDPA frame to indicate a decision result of the quantity of quantization bits. The step S1530 is similar to the step S1220.

In step S1540, the beamformee checks the decision result of the quantity of quantization bits in the NDPA frame. The beamformee checks the quantization bit field in the NDPA. The step S1540 is similar to the step S1230.

In step S1550, the beamformer transmits an NDP frame, or transmits an NDP frame and a BFRP trigger frame.

In step S1560, the beamformee calculates feedback angle vectors φ and v.

In step S1570, the beamformee quantizes φ and ψ based on the quantity of quantization bits. The quantity of quantization bits is determined based on the decision result. If the quantity of quantization bits is provided by the beamformer, the quantity of quantization bits may be found in the NDPA; and if the quantity of quantization bits is calculated by the beamformee, the quantity of quantization bits calculated by the beamformee in advance may be directly used.

In step S1580, the beamformee feeds back a beamforming report, that is, adds a new field to a multiple input multiple output control field in a compressed beamforming frame to indicate quantities b_{φ} and b_{ψ} of quantization bits for the two feedback angle vectors, for example, a φ and ψ quantization bit quantity subfield, which is the same as Embodiment 1.

In step S1590, the beamformer receives the beamforming report, and restores angle vectors based on the quantized φ and ψ, and the quantity of quantization bits.

Since inference duration of the AIML model is at a level of a channel sounding period, to perform inference by using the AIML model, an angle vector obtained in previous sounding may be used to perform AIML calculations, to obtain the optimal quantity of quantization bits in advance.

It may be understood that, in Embodiment 1 to Embodiment 4, the AIML model is used to assist in calculating the quantities of quantization bits for the beamforming feedback angle vectors, thereby achieving a balance between quantization overheads and quantization accuracy of the feedback angle vectors, and improving performance of a communications system. In addition, in this application, calculation time of the AIML model is classified into four levels, and different schemes are designed for different time levels.

The foregoing describes the method embodiments of this application in detail. The following describes apparatus embodiments of this application in detail. It should be understood that the descriptions of the method embodiments correspond to descriptions of the apparatus embodiments, and therefore, for parts that are not described in detail, reference may be made to the foregoing method embodiments.

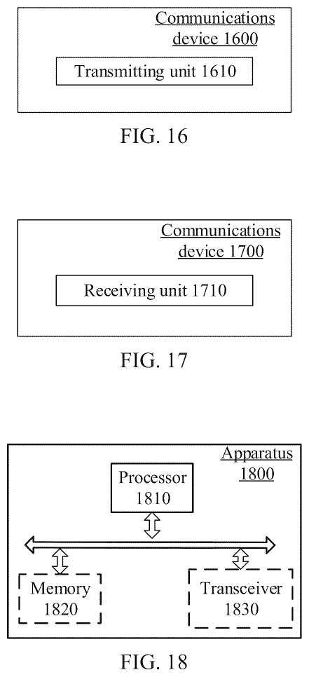

FIG. 16 is a schematic diagram of a structure of a communications device 1600 according to an embodiment of this application. The communications device 1600 is a first device. The communications device 1600 includes a transmitting unit 1610.

The transmitting unit 1610 is configured to transmit first indication information to a second device, where the first device is a device configured to determine a beamforming feedback angle, and the first indication information is used to indicate a first quantity of quantization bits for the beamforming feedback angle.

In some embodiments, the first quantity of quantization bits is determined based on one or more of the following information: the beamforming feedback angle; a second quantity of quantization bits specified by the second device according to a communication protocol; a feedback type; a subcarrier group; a codebook size; an MCS; an SNR; or an RSSI.

In some embodiments, the communications device 1600 is further configured to: receive second indication information transmitted by the second device, where the second indication information is used to indicate whether the first device is required to determine the first quantity of quantization bits.

In some embodiments, the second indication information is carried in a first field in the NDPA frame.

In some embodiments, the first field is a reserved field redefined in a STA Info field.

In some embodiments, in a case in which the second indication information is carried in the first field in the NDPA frame, at least one of a feedback type and subcarrier group field or a codebook size field in the NDPA frame is set as a reserved field.

In some embodiments, the first indication information is carried in a first information field in a beamforming report.

In some embodiments, the first information field is a multiple input multiple output control field.

In some embodiments, the first indication information is carried in a second field, a length of the second field is M bits, where Mis an integer greater than 0.

In some embodiments, the communications device 1600 is further configured to: receive a first frame, where the first frame is used to determine the beamforming feedback angle; where the transmitting the first indication information to the second device includes: transmitting the first indication information to the second device in response to receiving the first frame or a second frame, where the first frame is earlier than the second frame.

In some embodiments, the first frame includes a padding field.

In some embodiments, the second frame is a trigger frame for measuring the beamforming feedback angle.

In some embodiments, the trigger frame includes a MAC padding.

In some embodiments, a quantity of bits of the MAC padding L_{PAD,MAC} satisfies: L_{PAD,MAC}=N_{DBPS}×┌Tₘᵢₙ/T_{SYM}┐, where N_{DBPS} denotes a quantity of data bits per each OFDM symbol; T_{SYM} denotes duration corresponding to one OFDM symbol; and Tₘᵢₙ denotes minimum trigger frame processing duration required by the first device.

In some embodiments, the first frame is an NDPA frame.

In some embodiments, the first frame is a frame historically used to determine the beamforming feedback angle.

In some embodiments, a frame in response to which the first indication information is transmitted is determined based on first duration, where the first duration is processing duration for determining the first quantity of quantization bits.

In some embodiments, the first quantity of quantization bits is determined by using a first model.

In some embodiments, the first model is an AI model.

In an optional embodiment, the transmitting unit 1610 may be the transceiver 1830. The communications device 1600 may further include a processor 1810 and a memory 1820, which are specifically shown in FIG. 18.

FIG. 17 is a schematic diagram of a structure of another communications device 1700 according to an embodiment of this application. The communications device 1700 is a second device. The communications device 1700 includes a receiving unit 1710.

The receiving unit 1710 is configured to receive first indication information transmitted by a first device, where the first device is a device configured to determine a beamforming feedback angle, and the first indication information is used to indicate a first quantity of quantization bits for the beamforming feedback angle.

In some embodiments, the first quantity of quantization bits is determined based on one or more of the following information: the beamforming feedback angle; a second quantity of quantization bits specified by the second device according to a communication protocol; a feedback type; a subcarrier group; a codebook size; an MCS; an SNR; or an RSSI.

In some embodiments, the communications device 1700 is further configured to: transmit second indication information to the first device, where the second indication information is used to indicate whether the first device is required to determine the first quantity of quantization bits.

In some embodiments, the second indication information is carried in a first field in the NDPA frame.

In some embodiments, the first field is a reserved field redefined in a STA Info field.

In some embodiments, in a case in which the second indication information is carried in the first field in the NDPA frame, at least one of a feedback type and subcarrier group field or a codebook size field in the NDPA frame is set as a reserved field.

In some embodiments, the first indication information is carried in a first information field in a beamforming report.

In some embodiments, the first information field is a multiple input multiple output control field.

In some embodiments, the first indication information is carried in a second field, a length of the second field is M bits, where Mis an integer greater than 0.

In some embodiments, the communications device 1700 is further configured to: transmit a first frame, where the first frame is used to determine the beamforming feedback angle; where the receiving the first indication information transmitted by the first device includes: in response to transmitting the first frame or a second frame, receiving the first indication information transmitted by the first device, where the first frame is earlier than the second frame.

In some embodiments, the first frame includes a padding field.

In some embodiments, the second frame is a trigger frame for measuring the beamforming feedback angle.

In some embodiments, the trigger frame includes a MAC padding.

In some embodiments, a quantity of bits of the MAC padding L_{PAD,MAC} satisfies:

$${L}_{PAD , MAC} = {N}_{DBPS} \times ⌈ \frac{{T}_{min}}{{T}_{SYM}} ⌉ ,$$

where N_{DBPS} denotes a quantity of data bits per each OFDM symbol; T_{SYM} denotes duration corresponding to one OFDM symbol; and Tₘᵢₙ denotes minimum trigger frame processing duration required by the first device.

In some embodiments, the first frame is an NDPA frame.

In some embodiments, the first frame is a frame historically used to determine the beamforming feedback angle.

In some embodiments, a frame in response to which the first indication information is transmitted is determined based on first duration, where the first duration is processing duration for determining the first quantity of quantization bits.

In some embodiments, the first quantity of quantization bits is determined by using a first model.

In some embodiments, the first model is an AI model.

In an optional embodiment, the receiving unit 1710 may be a transceiver 1830. The communications device 1700 may further include a processor 1810 and a memory 1820, which are specifically shown in FIG. 18.

FIG. 18 is a schematic structural diagram of an apparatus for communication according to an embodiment of this application. Dashed lines in FIG. 18 indicate that a unit or module is optional. The apparatus 1800 may be configured to implement the methods described in the foregoing method embodiments. The apparatus 1800 may be a chip, a terminal device, or a network device.

The apparatus 1800 may include one or more processors 1810. The processor 1810 may support the apparatus 1800 in implementing the methods described in the foregoing method embodiments. The processor 1810 may be a general-purpose processor or a dedicated processor. For example, the processor may be a central processing unit (central processing unit, CPU). Alternatively, the processor may be another general-purpose processor, a digital signal processor (digital signal processor, DSP), an application-specific integrated circuit (application specific integrated circuit, ASIC), a field-programmable gate array (field programmable gate array, FPGA) or another programmable logic device, a discrete gate or transistor logic device, a discrete hardware component, or the like. The general-purpose processor may be a microprocessor, or the processor may be any conventional processor or the like.

The apparatus 1800 may further include one or more memories 1820. The memory 1820 stores a program, where the program may be executed by the processor 1810, to cause the processor 1810 to execute the methods described in the method embodiments. The memory 1820 may be separated from or integrated into the processor 1810.

The apparatus 1800 may further include a transceiver 1830. The processor 1810 may communicate with another device or chip by using the transceiver 1830. For example, the processor 1810 may transmit data to and receive data from another device or chip through the transceiver 1830.

An embodiment of this application further provides a computer-readable storage medium for storing a program. The computer-readable storage medium may be applied to a terminal or a network device provided in embodiments of this application, and the program causes a computer to execute the methods executed by the terminal or the network device in various embodiments of this application.

An embodiment of this application further provides a computer program product. The computer program product includes a program. The computer program product may be applied to a terminal or a network device provided in embodiments of this application, and the program causes a computer to execute the methods executed by the terminal or the network device in various embodiments of this application.

An embodiment of this application further provides a computer program. The computer program may be applied to a terminal or a network device provided in embodiments of this application, and the computer program causes a computer to execute the methods executed by the terminal or the network device in various embodiments of this application.

It should be understood that the terms “system” and “network” in this application may be used interchangeably. In addition, the terms used in this application are used only to illustrate specific embodiments of this application, but are not intended to limit this application. The terms “first”, “second”, “third”, “fourth”, and the like in the specification, claims, and drawings of this application are used to distinguish between different objects, rather than to describe a specific order. In addition, the terms “include” and “have” and any variations thereof are intended to cover a non-exclusive inclusion.

In embodiments of this application, “indication” mentioned herein may refer to a direct indication, or may refer to an indirect indication, or may mean that there is an association relationship. For example, if A indicates B, it may mean that A directly indicates B, for example, B may be obtained from A. Alternatively, it may mean that A indicates B indirectly, for example, A indicates C, and B may be obtained from C. Alternatively, it may mean that there is an association relationship between A and B.

In embodiments of this application, “B corresponding to A” means that B is associated with A, and B may be determined based on A. However, it should be further understood that, determining B based on A does not mean determining B based only on A, but instead, B may be determined based on A and/or other information.

In embodiments of this application, the term “correspond” may mean that there is a direct or indirect correspondence between the two, or may mean that there is an association relationship between the two, or may mean that there is a relationship such as indicating and being indicated, or configuring and being configured.

In embodiments of this application, “predefined” or “pre-configured” may be implemented by prestoring corresponding code, tables, or other forms that may be used to indicate related information in devices (for example, including an STA and an AP), and a specific implementation thereof is not limited in this application. For example, being predefined may refer to being defined in a protocol.

In embodiments of this application, the term “and/or” describes merely an association relationship between associated objects, and represents that there may be three relationships. For example, A and/or B may represent three cases: only A exists, both A and B exist, and only B exists. In addition, the character “/” in this specification generally indicates an “or” relationship between the associated objects.

In embodiments of this application, the “include” may refer to direct inclusion, or may refer to indirect inclusion. Optionally, the term “include” mentioned in embodiments of this application may be replaced with “indicate” or “be used to determine”. For example, A including B may be replaced with that A indicates B, or A is used to determine B.

In embodiments of this application, sequence numbers of the foregoing processes do not mean execution orders. The execution orders of the processes should be determined based on functions and internal logic of the processes, and should not be construed as any limitation on the implementation processes of embodiments of this application.

In several embodiments provided in this application, it should be understood that the disclosed system, apparatus, and method may be implemented in another manner. For example, the described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented as indirect couplings or communication connections through some interfaces, apparatus or units, and may be implemented in electronic, mechanical, or other forms.

The units described as separate parts may or may not be physically separate, and parts displayed as units may or may not be physical units, and may be located in one position, or may be distributed on a plurality of network units. Some or all of the units may be selected according to actual needs to achieve the objective of the solutions of embodiments.

In addition, functional units in embodiments of this application may be integrated into one processing unit, or each of the units may exist alone physically, or two or more units may be integrated into one unit.

All or some of the foregoing embodiments may be implemented by using software, hardware, firmware, or any combination thereof. When software is used to implement embodiments, the foregoing embodiments may be implemented completely or partially in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (for example, a coaxial cable, an optical fiber, and a digital subscriber line (DSL)) manner or a wireless (for example, infrared, wireless, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid-state drive (SSD)), or the like.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A communications device, wherein the communications device is a first device, and the communications device comprises: a memory and a processor, the memory is configured to store a computer program, and the processor is configured to execute the computer program stored in the memory to cause the first device to perform an operation of:
transmitting first indication information to a second device,
wherein the first device is a device configured to determine a beamforming feedback angle, and the first indication information is used to indicate a first quantity of quantization bits for the beamforming feedback angle.

2. The communications device according to claim 1, wherein the first quantity of quantization bits is determined based on one or more of following information:
the beamforming feedback angle;
a second quantity of quantization bits specified by the second device according to a communication protocol;
a feedback type;
a subcarrier group;
a codebook size;
a modulation and coding scheme MCS;
a signal-to-noise ratio SNR; or
a received signal strength indicator RSSI.

3. The communications device according to claim 1, wherein the communication device is further configured to:
receive second indication information transmitted by the second device,
wherein the second indication information is used to indicate whether the first device is required to determine the first quantity of quantization bits.

4. The communications device according to claim 3, wherein the second indication information is carried in a first field in a null data packet announcement NDPA frame.

5. The communications device according to claim 4, wherein the first field is a reserved field redefined in a station information field.

6. The communications device according to claim 4, wherein in a case in which the second indication information is carried in the first field in the NDPA frame, at least one of a feedback type and subcarrier group field or a codebook size field in the NDPA frame is set as a reserved field.

7. The communications device according to claim 1, wherein the first indication information is carried in a first information field in a beamforming report.

8. The communications device according to claim 7, wherein the first information field is a multiple input multiple output control field.

9. The communications device according to claim 7, wherein the first indication information is carried in a second field, a length of the second field is M bits, wherein M is an integer greater than 0.

10. The communications device according to claim 1, wherein the first quantity of quantization bits is determined by using a first model.

11. The communications device according to claim 10, wherein the first model is an AI model.

12. A communications device, wherein the communications device is a second device, and the communications device comprises: a memory and a processor, the memory is configured to store a computer program, and the processor is configured to execute the computer program stored in the memory to cause the second device to perform an operation of:
receiving first indication information transmitted by a first device,
wherein the first device is a device configured to determine a beamforming feedback angle, and the first indication information is used to indicate a first quantity of quantization bits for the beamforming feedback angle.

13. The communications device according to claim 12, wherein the first quantity of quantization bits is determined based on one or more of following information:
the beamforming feedback angle;
a second quantity of quantization bits specified by the second device according to a communication protocol;
a feedback type;
a subcarrier group;
a codebook size;
a modulation and coding scheme MCS;
a signal-to-noise ratio SNR; or
a received signal strength indicator RSSI.

14. The communications device according to claim 12, wherein the communication device is further configured to:
transmit second indication information to the first device,
wherein the second indication information is used to indicate whether the first device is required to determine the first quantity of quantization bits.

15. The communications device according to claim 14, wherein the second indication information is carried in a first field in a null data packet announcement NDPA frame.

16. The communications device according to claim 15, wherein the first field is a reserved field redefined in a station information field.

17. The communications device according to claim 15, wherein in a case in which the second indication information is carried in the first field in the NDPA frame, at least one of a feedback type and subcarrier group field or a codebook size field in the NDPA frame is set as a reserved field.

18. The communications device according to claim 12, wherein the first indication information is carried in a first information field in a beamforming report.

19. The communications device according to claim 18, wherein the first information field is a multiple input multiple output control field; and/or
wherein the first indication information is carried in a second field, a length of the second field is M bits, wherein Mis an integer greater than 0.

20. A wireless communication method, comprising:
transmitting, by a first device, first indication information to a second device,
wherein the first device is a device configured to determine a beamforming feedback angle, and the first indication information is used to indicate a first quantity of quantization bits for the beamforming feedback angle.
